(19) United States
(12) Patent Application Publication
(10) Pub. No.: US 2023/0211687 A1
(43) Pub. Date: Jul. 6, 2023

(54) CHARGING POLE

(71) Applicant: ME ENERGY GMBH, Wildau (DE)

(72) Inventors: Alexander SOHL, Berlin (DE); Inès ADLER, Berlin (DE)

(73) Assignee: ME ENERGY GMBH, Wildau (DE)

(21) Appl. No.: 18/000,400

(22) PCT Filed: Jun. 1, 2021
(86) PCT No.: PCT/EP2021/064682

§ 371 Date: Dec. 1, 2022

(30) Foreign Application Priority Data
Jun. 2, 2020 (DE) 10 2020 114 677.9

(51) Int. Cl. B60L 53/57; B60L 53/53; B60L 53/18

(52) U.S. Cl. CPC B60L 53/57; B60L 53/53; B60L 53/18; B60L 53/54

(57) ABSTRACT

The invention relates to a method for generating and delivering charging current for an electric vehicle in a charging pole having the method steps of registering a first initial process, evaluating the first initial process, starting the charging process as a function of the evaluation result, the first initial process being different from a start command of a user for starting a charging process, and a charging pole for carrying out the method.

The invention relates to a method for generating and delivering charging current for an electric vehicle in a charging pole comprising the steps of registering a first initial process for charging an electric vehicle, starting a process for energy conversion, starting a process for charging an electric vehicle, terminating the process for energy conversion and terminating the process for charging an electric vehicle as well as a device for carrying out the method.

### STATE OF THE ART

The spread of electric vehicles powered by an electric motor must be accompanied by a functioning infrastructure for charging electric vehicles. In addition to charging at the household socket, users of electric vehicles must be given the opportunity to obtain energy in public areas. With the currently available ranges of electric vehicles, it is necessary that charging of the vehicles is also possible outside the domestic environment. Therefore, charging stations must be made available in public areas to ensure a constant availability of energy for electric vehicles through a supply network.

Charging poles are known for recharging the traction battery of a plug-in vehicle—hybrid or electric vehicle—as described, for example, in DE 10 2009 016 505 A1. The charging pole itself is connected to a bus bar of the power supply. An existing power grid has a connection element for outputting electrical energy to an electric vehicle.

It is therefore the task of the present invention to provide a method for charging electric vehicles with which the charging time can be reduced. Furthermore, it is the task of the present invention to provide a corresponding device.

The task is solved by means of the Method for generating and delivering charging current for an electric vehicle in a charging pole according to claim 1. Further advantageous embodiments of the invention are set out in the subclaims.

The Method for generating and delivering charging current for an electric vehicle in a charging pole according to the invention has five process steps. In the first process step, a first initial process for charging an electric vehicle is registered. The first initial process signals the readiness of a user to charge an electric vehicle. The first initial process can be registered by an active user input in the immediate vicinity of the charging pole. An input into an HMI unit at the charging pole is possible, for example. Input via a smartphone or the vehicle from a physical distance to the charging pole is also conceivable. Advantageously, the first initial process can also be registered without active user input, e.g. by parking an electric vehicle to be charged in the immediate or indirect vicinity of the charging pole.

In the second process step, an energy conversion process is started. Depending on the design of the charging pole, an energy conversion requires a lead time in order to be able to deliver maximum power to the electric vehicle during a charging process. For example, the lead time of an energy conversion from light to electricity by e.g. a solar cell or wind to electricity by a wind turbine is shorter than the lead time of an energy conversion of a liquid and/or gaseous energy carrier by e.g. a combustion engine. By suitably selecting the start time of an energy conversion by means of a combustion engine, the charging process for a user is significantly reduced.

In the third process step, a process for charging an electric vehicle is started. The charging pole emits electrical energy to the electric vehicle during the charging process based on experience. The electric vehicle is connected to the charging pole via a charging cable during the charging process. Inductive charging of the electric vehicle is also possible.

In the fourth step, the energy conversion process is terminated. The energy conversion device is stopped. In the fifth process step, the process for charging an electric vehicle is terminated. This can be done, for example, by user input, disconnection of a charging cable or automatically when the electric vehicle is fully charged. According to the invention, the ratio of the amount of electrical energy E_{K} generated during the charging process to the amount of electrical energy E_{A} delivered to the electric vehicle to be charged is greater than 1 (E_{K}/E_{A}>1).

In the context of this disclosure, the charging process includes the process steps two to four, i.e. from the start of a process for energy conversion to the completion of the process for charging the electric vehicle to be charged. The charging process thus includes the actual process for charging an electric vehicle and additionally the process of energy conversion in the charging pole.

The additional surplus energy generated during the energy conversion process for the charging process can be used to charge the electric vehicle to be charged and/or another electric vehicle. Thus, the time of the charging process for this further second electric vehicle can also be shortened if, after charging of a first electric vehicle has been completed, the energy E_{A} is fed into the second electric vehicle, i.e. the nominal power of the charging pole is available for the second electric vehicle. The method according to the invention therefore shortens the duration of charging an electric vehicle by storing the energy generated during the charging process and delivering it to an electric vehicle to be charged when required.

For the purposes of this disclosure, a charging pole is understood to be a charging device which, due to its compact design, can find space on a narrow pavement or can replace a fuel dispenser at a petrol station, but has a maximum space smaller than the space of a standard car parking space. The charging pole is designed as a column, i.e. it has a height H which is at least 20% greater than its width B and/or depth T. A charging pole within the meaning of the present invention does not have a space which can be entered by a human being. A charging pole is therefore neither a container nor a building. Rather, the charging poles according to the invention have a very compact design in which the structure is adapted to the designated space and not—as in container solutions, for example—the standard size of the enclosure dictates the external dimensions. In the charging pole according to the invention, the ratio of the volume V_{N} used by components and/or the air ducting for cooling to the enclosed volume V_{G} is therefore 0.8 or more (V_{N}/V_{G}>0.8), preferably 0.85 (V_{N}/V_{G}>0.85) or more and particularly preferably 0.9 or more (V_{N}/V_{G}>0.9).

In a further embodiment of the invention, the energy conversion device supplies more than 50% of the total charging power of electrical energy of a charging process of an electric vehicle, preferably the energy conversion device supplies more than 75% of the total charging power of electrical energy of a charging process of an electric vehicle, particularly preferably more than 90%. In an optional embodiment, the charging pole operates autonomously and the energy conversion device supplies 100% of the total charging power of electrical energy of a charging process of an electric vehicle. In a further optional embodiment of the invention, methanol and/or ethanol is converted into electrical energy.

In another advantageous embodiment of the invention, the ratio of the amount of electrical energy E_{K} generated during the charging process to the amount of electrical energy E_{A} delivered to the electric vehicle to be charged and the amount of electrical energy loss E_{V} is greater than 1 (E_{K}/(E_{A}+E_{V})>1).

The loss energy E_{V} denotes the difference—unavoidable for technical systems—between the electrical energy E_{K} generated during the process of energy conversion and the useful energy emitted during an energy conversion. The loss energy E_{V} is mainly emitted to the environment as heat energy. In particular, the amount of electrical energy loss E_{V} does not include the amount of electrical energy required, consumed and/or stored to operate the charging pole. In order to compensate for these energy losses E_{V}, a charging pole can generate or provide more electrical energy than actually needed for charging. The process according to the invention therefore not only compensates for the loss energy E_{V} that is present in every technical device, but also generates significantly more electrical energy E_{K} during the charging process, which is stored and available for further applications, e.g. processes for charging electric vehicles.

In a further embodiment of the invention, the ratio of the amount of electrical energy E_{K} generated during the charging process to the amount of electrical energy E_{A} delivered to the electric vehicle to be charged and the amount of electrical loss energy E_{V} and, in addition, the amount of electrical energy E_{S} stored during the charging process is greater than 1 (E_{K}/(E_{A}+E_{V}+E_{S})>1). The process according to the invention not only compensates for the loss energy E_{V} that is present in every technical device, but also generates significantly more electrical energy E_{K} during the charging process, which is available, for example, for the operation of the charging pole. The stored energy E_{S} can be used for the operation of the charging pole as well as for further operations to charge electric vehicles, thus reducing the charging time. The storage of electrical energy E_{S} can take place inside or outside a charging pole. Storage media can be e.g. thermal (e.g. thermochemical storage), chemical (e.g. electrolysis), mechanical (e.g. flywheel) or electrical energy (e.g. capacitor).

In a further embodiment of the invention, the electrical energy E_{S} is stored in an electrical energy storage device. The electrical energy storage device is usually a rechargeable battery, e.g. a Li-ion battery or an acid battery. Such an energy storage device has a high energy density, is technically mature and available and, depending on its energy content (capacity), requires so little space that it can be arranged in a charging pole.

In another embodiment of the invention, the amount of additional energy generated E_{M}=E_{K}−(E_{A}+E_{V}+E_{S}) is greater than or equal to 1 kWh. The additional generated energy E_{M} is therefore significantly higher than is required to compensate for the energy loss E_{V} and to ensure the charging of an electric vehicle and the operation of the charging pole. The additional generated energy E_{M} is essentially stored both for the operation of the charging pole and in an energy storage device and used for further charging processes to charge electric vehicles. The rapid availability of the stored energy therefore reduces the charging time of subsequent charging processes, as energy is available for charging before the energy conversion device can deliver charge.

In a further embodiment of the invention, the amount of additional energy generated E_{M}=E_{K}−(E_{A}+E_{V}+E_{S}) is less than or equal to 50 kWh. The additional energy E_{M} generated during the charging process is used for the operation of the charging pole as well as for further processes for charging electric vehicles and therefore shortens the charging time. To limit the size of the components required for energy generation in the charging pole, in particular energy conversion device and energy storage, the amount of additional generated energy E_{M} is limited to 50 kWh. This limits the weight, dimensions and thus costs of the charging pole.

In another embodiment of the invention, the amount of stored electrical energy E_{S} is greater than or equal to 5 kWh. The amount of stored electrical energy E_{S} depends on the capacity of the energy storage device. It has been found that for further use of the stored electrical energy E_{S}, an amount less than 5 kWh is not sufficient.

In an advantageous further development of the invention, part of the additional generated electrical energy E_{M} is delivered to a second electric vehicle to be charged in parallel. The additional surplus energy generated during the energy conversion process for the charging process is used to charge another electric vehicle. In this way, the time of the charging process for this additional second electric vehicle can be shortened if the energy E_{A} is fed into the second electric vehicle after the charging of a first electric vehicle has been completed, i.e. the nominal power of the charging pole is available for the second electric vehicle after the charging process for the first electric vehicle has been completed.

In a further embodiment of the invention, part of the additional generated electrical energy E_{M} is used to operate the charging pole. The charging pole is thus operated autonomously during the charging process by the energy conversion process. It is not necessary to connect the charging pole to an external energy source, e.g. a power line, and the costs for installing the charging pole are thus reduced.

In a further embodiment of the invention, the energy conversion comprises the conversion of a liquid and/or gaseous energy carrier into electrical energy. The energy carrier can be a conventional petrol or diesel fuel, but preferably an alkanol (methanol, ethanol and/or a mixture of methanol and ethanol), which can be produced from organic substances in a CO₂-neutral manner and has been tried and tested as a fuel for a long time. Liquefied or compressed gases, e.g. natural gas or hydrogen, can also be used as fuel. The energy conversion device is usually a combustion engine, but a fuel cell is also possible, e.g. a methanol-fuelled direct methanol fuel cell or a hydrogen-fuelled fuel cell.

In another embodiment of the invention, the liquid energy carrier is stored in a tank in the charging pole. The storage of the tank in the charging pole itself reduces the space requirement of the charging pole. The tank is suitably designed according to the type of energy carrier used and is corrosion-resistant to the energy carrier used. In the case of the use of liquefied or compressed gases, e.g. natural gas or hydrogen, the tank is additionally thermally insulated or pressure-tight. The tank can be designed in one or more parts. It is also possible to design the tank as a swap tank, which makes it easier and faster to supply the charging pole with fuel by swapping the empty tank for a full tank and refilling it externally.

The task is further solved by the charging pole according to the invention, which is suitable for charging electric vehicles and is provided therefor, according to claim 12.

The charging pole according to the invention, which is suitable for charging electric vehicles, has an energy conversion device and a generator unit connected to the energy conversion device. A rectifier is connected to the generator unit, and the rectifier is in turn connected to a connection for a charging cable via a power line. According to the invention, a consumer and/or an energy storage device is connected to the generator unit via a power line. The power line is suitable and intended for transmitting electrical energy for operating the consumer or for storing the electrical energy. When storing the energy, a charger can be arranged between the generator unit and the energy storage device.

The charging pole according to the invention transfers electrical energy to the consumer, e.g. to the energy storage unit of an electric vehicle to be charged or to a device of the charging pole. The energy is transferred by a power line between the generator unit and the consumer. A power line between the generator unit and the energy storage device also enables storage of the electrical energy generated by the generator unit. The stored electrical energy can also be available for a consumer.

In a further embodiment of the invention, the energy conversion device is the only energy source that provides electrical energy to power a charging process. In an optional further embodiment, the electrical energy is temporarily stored in a battery. In a further optional embodiment of the invention, the energy source for energy conversion is methanol and/or ethanol. Accordingly, the energy conversion device is an energy conversion device suitable, intended and designed for converting ethanol and/or methanol into electrical energy.

In another embodiment of the invention, the consumer has a power unit and/or an HMI (human-machine interface) unit. By means of the HMI unit, the data important for a user, such as charging current, charging time and costs of the charging process, are retrieved and displayed. In addition, a user can initiate or end the charging process and pay. Various payment systems are possible, e.g. via different credit cards. Other payment systems are also possible, e.g. via a mobile end device (smartphone). The power unit primarily enables the conversion of electrical energy in terms of the voltage form (e.g. direct or alternating voltage), the level of voltage and current as well as the frequency.

In another embodiment of the invention, the HMI unit comprises a screen, a control device, a sensor unit, a communication unit and/or a control unit. By means of the screen and the operating device, data important to a user, such as charging current, charging time and cost of the charging process, are retrieved and displayed. In addition, a user can initiate or end the charging process and pay. The charging pole is connected to the operator of the charging pole and/or a plurality of charging poles via the communication unit, which establishes an internet connection, e.g. with a management system or a cloud storage. Sensors, e.g. a radar sensor, detect the electric vehicle to be charged at the parking space assigned to the charging pole.

In a further embodiment of the invention, the battery is connected to the energy conversion device via a power line. The power line is suitable and intended to transmit electrical energy for starting and/or operating the energy conversion device. The charging pole is therefore operated autonomously by the electrical energy stored in the battery. It is not necessary to connect the charging pole to an external energy source, e.g. a power line; the costs for installing the charging pole are thus reduced.

In another embodiment of the invention, the battery is connected to the HMI/power unit via a power line. The power line is suitable and intended to transmit electrical energy for starting, standby and/or operation of the HMI/power unit. The standby mode of the charging pole requires a small amount of energy supply to the HMI unit and the power unit to ensure functionality. This energy supply is provided by the battery. Start-up and operation of the HMI unit and the power unit also take place with stored electrical energy in the battery. The charging pole is therefore operated autonomously by the electrical energy stored in the battery. Connecting the charging pole to an external energy source, e.g. a power line, is not necessary; the costs for installing the charging pole are thus reduced.

In another embodiment of the invention, the battery is connected to the charging cable via a power line. The power line is suitable and intended for transmitting electrical energy to the charging cable for charging the electric vehicle. The electrical energy stored in the battery is conducted through the charging cable to the energy storage device of the electric vehicle to be charged, thereby charging the energy storage device of the electric vehicle.

In a further embodiment of the invention, the battery is connected to the rectifier via a power line. The power line is suitable and intended for transmitting electrical energy to the rectifier for conversion of the current. The electrical energy stored in the battery is conducted as direct current to the energy storage unit of the electric vehicle to be charged. The rectifier functions in particular as a power unit that adjusts the charging state of the electric vehicle to be charged, the charging voltage and the charging current of the charging pole. The charging pole according to the invention thus charges an electric vehicle to be charged not only with the electrical energy generated by the generator unit, but also additionally with the electrical energy stored in the battery. This significantly shortens the charging time. Alternatively, a second electric vehicle can be charged in parallel.

In another aspect of the invention, the battery is connected to the rectifier via an inverter. The electrical energy stored in the battery is fed as direct current to the inverter, which converts the direct current into an alternating current. The rectifier connected afterwards converts the alternating current back into direct current. The inverter and rectifier both function as a power unit that adjusts the charging state of the electric vehicle to be charged, the charging voltage and the charging current of the charging pole.

In an advantageous embodiment of the invention, the battery is connected to the generator unit via a power line. The power line is suitable and intended for storing the electrical energy transmitted by the generator unit in the battery. The stored energy can be used for the operation of the charging pole as well as for further operations for charging electric vehicles, thus reducing the charging time. Optionally, a charger is placed between generator unit and battery.

Examples of embodiments of the process for generating and delivering charging current in a charging pole for an electric vehicle and of the charging pole according to the invention are shown schematically in simplified form in the drawings and are explained in more detail in the following description.

Showing:

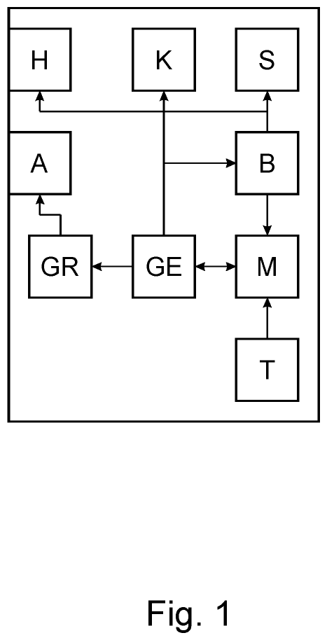

FIG. 1: An example of the charging pole according to the invention.

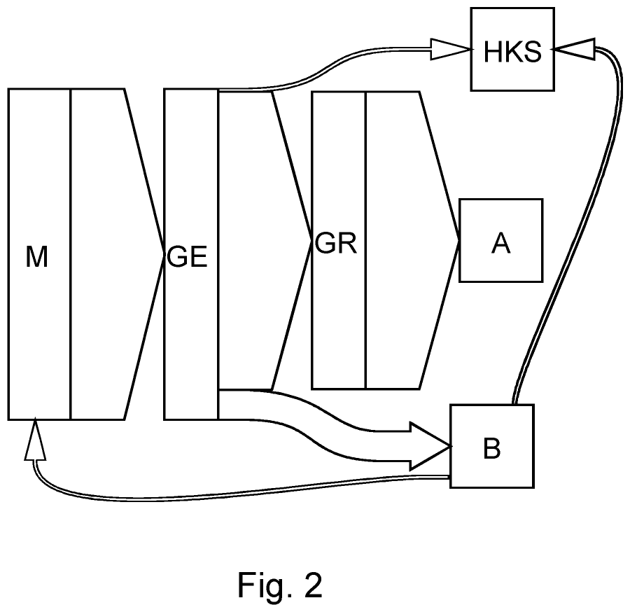

FIG. 2: A diagram of an example of energy distribution during the charging process.

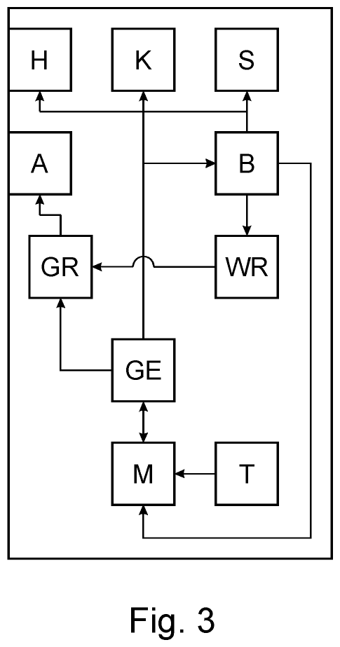

FIG. 3: A further example of the charging pole according to the invention.

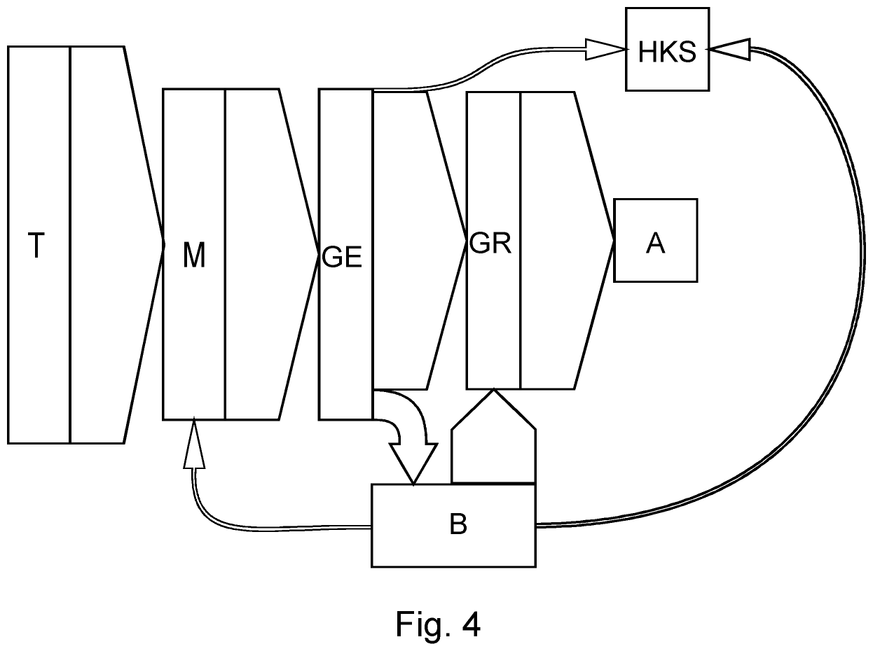

FIG. 4: A diagram of another embodiment of energy distribution during the charging process.

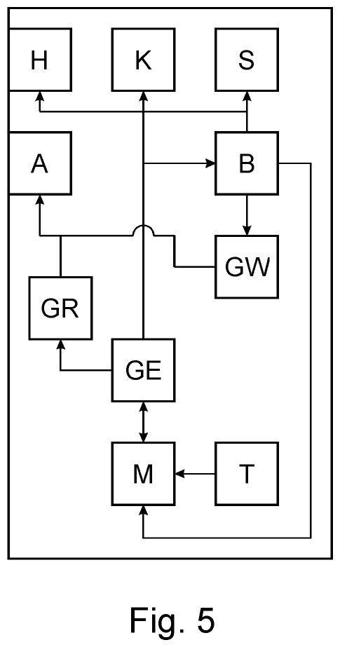

FIG. 5: Another example of the charging pole according to the invention.

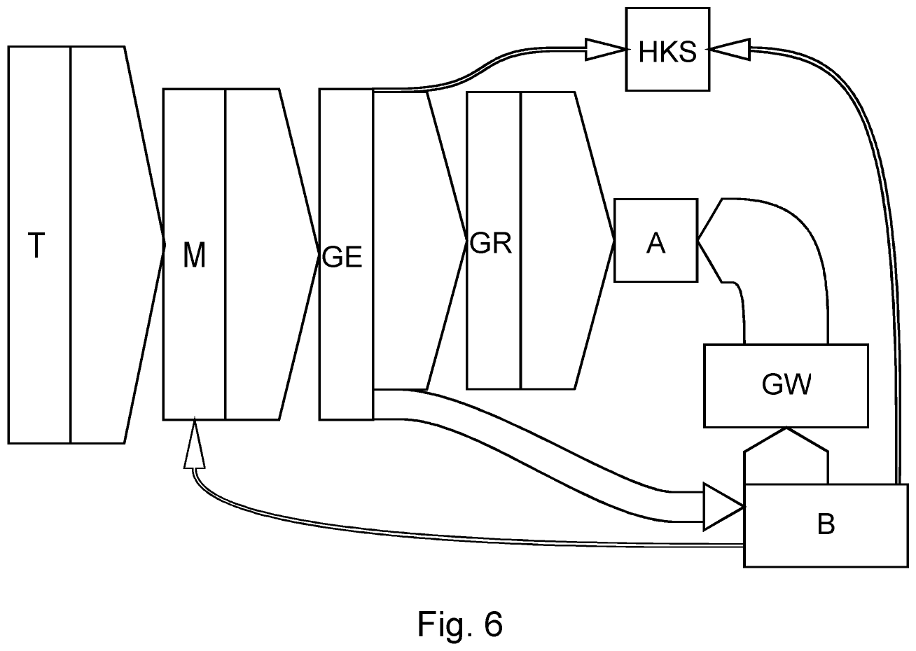

FIG. 6: A diagram of another embodiment of the energy distribution during the charging process.

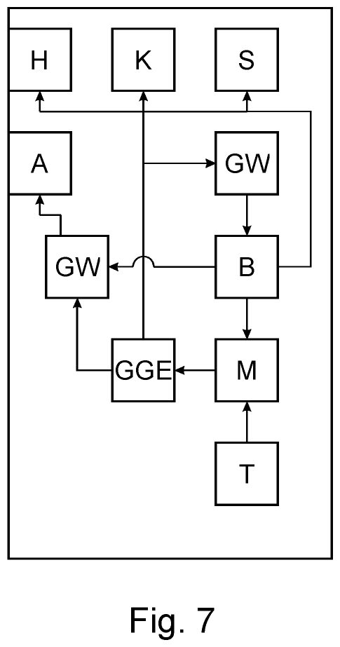

FIG. 7: Another example of the charging pole according to the invention.

FIG. 1 shows a schematic view of the charging pole 1 according to the invention with representation of the connections by means of power lines between the components within the charging pole 1. In this and the following embodiment examples, the charging pole 1 according to the invention has a nominal power of 150 kW, i.e. an electric vehicle can be charged with 150 kW charging power. In the charging pole 1, in this embodiment example, the electrical energy for delivery to an electric vehicle is generated by a combustion engine M. The combustion engine M is here a piston combustion engine with a shaft power of 180 kW, but other designs such as a Wankel engine or turbine are also possible. The combustion engine M is advantageously operated with methanol or ethanol or a mixture of methanol and ethanol. The fuels can be produced in a climate-neutral manner, e.g. from vegetable raw materials, and their storage and handling is comparable to the storage of conventional petrol and therefore does not require any extraordinary safety measures for safe storage and transport. Such a fuel typically has a usable energy content of 6.28 kWh/I and is the primary energy source. The fuel is stored in the charging pole 1 in a tank T.

The combustion engine M drives the generator GE by rotation. The kinetic energy generated by the combustion engine M is thus converted into electrical energy by the generator GE, into an alternating current. The generator GE generates an electrical power of approx. 165 kW. The alternating current generated by the generator GE is converted into a direct current in the rectifier GR.

The HMI unit H has a display and operating terminal on which the data important to a user, such as charging current, charging duration and costs of the charging process, are retrieved and displayed. In addition, a user can initiate or end the charging process and pay. Various payment systems are possible, e.g. via different credit cards. Other payment systems are also possible, e.g. via a mobile end device (smartphone).

In this embodiment example, the rechargeable battery B (rechargeable electric energy storage unit or battery) has a capacity of 50 kWh and is charged by the generator GE during the charging process. At the same time, the battery B supplies the control unit S, the communication unit K and the HMI unit H with electrical energy for operation as well as the combustion engine M with electrical energy for starting and operation.

The charging pole 1 also has the connection device A for one or more charging cables with which an electric vehicle to be charged is charged. The charging cable also has a data line that establishes a data connection between the control unit S and the electric vehicle. Communication with the battery of the electric vehicle to be charged is established via the data line and the required data such as state of charge, charging voltage and charging current are queried. The control unit S sets the parameters of the charging current based on this data. The charging pole 1 is connected to the operator of the charging pole 1 and a plurality of charging poles via the communication unit K, which establishes an internet connection, e.g. with a management system or alternatively with a cloud storage.

All these components for the charging pole 1 mentioned here—tank T, combustion engine M, generator GE, rectifier GR, connection device A, battery B, HMI unit H, communication unit K, control unit S—are advantageously arranged in the charging pole 1 itself. For this purpose, the charging pole 1 has a housing that protects the components inside the charging pole 1 from the effects of the weather and damage.

The procedure for charging an electric vehicle begins with a registration of a first initial process. Up to this point, the charging pole 1 is in a stand-by mode in which only the control unit S, the communication unit K and the HMI unit H are operational. These units H, K, S are supplied with energy by the battery B. In this example, the control unit S, the communication unit K and the HMI unit H require 70 W for stand-by operation.

In this embodiment, the first initial process is registered by the connection of the charging cable to the electric vehicle to be charged, i.e. by means of a plug-in connection, charging pole 1 and electric vehicle are connected by the charging cable attached to connection device A. The first initial process can also be registered by sensors, e.g. a radar sensor, which detects the electric vehicle to be charged at the parking space assigned to the charging pole 1. It is also possible to pre-announce a user by means of a mobile end device, e.g. a smartphone with a suitable app, which starts a charging process at a time window specified in the first initial process. A combination of the aforementioned possibilities for registering a first initial process is also conceivable.

The first initial process puts charging pole 1 into an operating state. For this purpose, the energy conversion process is started first. A starting device installed on the combustion engine M starts the combustion engine M, which is supplied with fuel from the tank T. The combustion engine M is started by an electric motor. For the start and operation of the combustion engine M, an electrical power of 500 W is required, which is provided by the battery B. The battery is then charged. Then the process of charging the electric vehicle is carried out by the electrical energy generated by the generator GE. Typically, a user gives a start command for charging via the HMI unit H. The electric vehicle is supplied with electrical energy by the charging pole 1 through the charging cable connected to the connection device A, in this embodiment example with a maximum of 150 kW.

After the electric vehicle has been charged, the energy conversion process is terminated, the combustion engine M is stopped and the process of charging the electric vehicle is terminated. No more electrical energy flows from the charging pole 1 to the electric vehicle. The charging pole 1 is returned to the stand-by mode.

According to the invention, the ratio of the amount of electrical energy E_{K} generated during the charging process to the amount of electrical energy E_{A} delivered to the electric vehicle to be charged is greater than 1, i.e. the charging pole 1 generates more electrical energy than is delivered to the electric vehicle. In this embodiment example, the more generated electrical energy output is 30 kW, and according to the invention between 1 kWh and 50 kWh more generated energy is provided during the charging process. This amount of additional generated energy depends, among other things, on the duration of the charging process or the charging power with which an electric vehicle is charged.

An example of the energy flow during the charging process between the components of the charging pole 1 is shown in FIG. 2. The combustion engine M generates a nominal power of 180 kW, which is transmitted to the generator GE. The generator GE generates an electrical power of 170 kW. Of this 170 kW of electrical power, 10 kW is fed into the battery B to charge it. A further 70 W of the energy output generated by the generator GE is used to supply power to the control unit S, the communication unit K and the HMI unit H. Therefore, 160 kW (minus 70 W for the operation of control unit S, communication unit K and HMI unit H) enters rectifier GR. The alternating current produced by the generator GE is converted into a direct current in the rectifier GR.

The direct current (around 150 kW) generated by the rectifier GE is fed into the charging cable located at the connection device A. The battery B, with a capacity of 50 kWh, supplies the control unit S, the communication unit K and the HMI unit H with a total of 70 W and the combustion engine M with 500 W in the stand-by mode. The ratio of the amount of electrical energy E_{K} generated during the charging process to the amount of electrical energy E_{A} delivered to the electric vehicle to be charged is advantageously greater than 1 (E_{K}/E_{A}>1).

The additional electrical energy output is 30 kW; according to the invention, between 1 kWh and 50 kWh additional energy is generated during the charging process. This amount of additional generated energy depends, among other things, on the duration of the charging process or on the charging power with which an electric vehicle is charged. The procedure for charging an electric vehicle begins with a registration of a first initial process. Up to this point, the charging pole 1 is in stand-by mode in which only the control unit S, the communication unit K and the HMI unit H are operational.

The first initial process is registered by connecting the charging cable to the electric vehicle to be charged, i.e. by means of a plug-in connection, charging pole 1 and electric vehicle are connected by the charging cable connected to connection device A. The first initial process puts the charging pole 1 into an operating state. For this purpose, the energy conversion process is started first. A starting device installed on the combustion engine M starts the combustion engine M, which is supplied with fuel from the tank T. The charging process is then started. Then the process of charging the electric vehicle by the electrical energy generated by the generator GE takes place. The electric vehicle is supplied with approximately 150 kW of electrical energy power by the charging pole 1 through the charging cable connected to the connection device A. Once the electric vehicle has been charged, the energy conversion process is terminated, the combustion engine M is stopped and the process of charging the electric vehicle is terminated. The charging pole 1 is returned into stand-by mode.

FIG. 3 shows a schematic view of the charging pole 1 according to the invention with representation of the connections by means of power lines between the components within the charging pole 1. In this embodiment example, the charging pole 1 has an inverter WR. In the charging pole 1, the electrical energy for delivery to an electric vehicle is generated by the combustion engine M. The combustion engine M is a piston combustion engine with a shaft power of 180 kW, the combustion engine M is operated with methanol or ethanol or a mixture of methanol and ethanol. The fuel is stored in the charging pole 1 in the tank T.

The combustion engine M drives the generator GE by rotation. The kinetic energy generated by the combustion engine M is thus converted into electrical energy by the generator GE, into an alternating current. The generator GE produces an electrical power of 180 kW. The alternating current generated by the generator GE is converted into a direct current in the rectifier GR.

The HMI unit H has the display and operating terminal on which the data important for a user, such as charging current, charging duration and costs of the charging process, are retrieved and displayed. In addition, a user can initiate or end the charging process and pay.

The rechargeable battery B (battery) has a capacity of 50 kWh and is charged by the generator GE during the charging process. At the same time, the battery B supplies the control unit S, the communication unit K and the HMI unit H with electrical energy for operation and the combustion engine M with electrical energy for starting and operation.

The charging pole 1 also has the connection device A for one or more charging cables with which an electric vehicle to be charged is charged. The charging cable also has a data line that establishes a data connection between the control unit S and the electric vehicle. Communication with the battery of the electric vehicle to be charged is established via the data line and the required data such as state of charge, charging voltage and charging current are queried. The control unit S sets the parameters of the charging current based on this data. The charging pole 1 is connected to the operator of the charging pole 1 and a plurality of charging poles via the communication unit K, which establishes an internet connection, e.g. with a cloud storage.

In this example, the battery B is connected to the connection device A for the charging cable via an inverter WR and the rectifier GR. During the charging process, the inverter GW and rectifier GR function as a power unit that adjusts the charging state of the electric vehicle to be charged, the charging voltage and the charging current of the charging pole 1.

The procedure for charging an electric vehicle begins with a registration of a first initial process. Up to this point, the charging pole 1 is in a stand-by mode in which only the control unit S, the communication unit K and the HMI unit H are operational. These units H, K, S are supplied with energy by the battery B. The control unit S, the communication unit K and the HMI unit H require 70 W for stand-by operation.

The first initial process is registered by connecting the charging cable to the electric vehicle to be charged, i.e. by means of a plug-in connection, charging pole 1 and electric vehicle are connected by the charging cable connected to connection device A. The first initial process puts the charging pole 1 into an operating state. For this purpose, the energy conversion process is started first. A starting device installed on the combustion engine M starts the combustion engine M, which is supplied with fuel from the tank T. The combustion engine M is started by the starting device. For the start and operation of the combustion engine M, an electrical power of 500 W is required, which is provided by the battery B. The battery is then charged. Then the process of charging the electric vehicle is carried out by the electrical energy generated by the generator GE. Typically, a user gives a start command for charging via the HMI unit H. The electric vehicle is supplied with electrical energy by the charging pole 1 through the charging cable connected to the connection device A, in this embodiment example with a maximum of 150 kW.

After the electric vehicle has been charged, the energy conversion process is terminated, the combustion engine M is stopped and the process of charging the electric vehicle is terminated. No more electrical energy flows from the charging pole 1 to the electric vehicle.

The charging pole 1 is returned into stand-by mode. According to the invention, the ratio of the amount of electrical energy E_{K} generated during the charging process to the amount of electrical energy E_{A} delivered to the electric vehicle to be charged is greater than 1, i.e. the charging pole 1 generates more electrical energy than is delivered to the electric vehicle. The more generated electrical energy output is 30 kW, according to the invention between 1 kWh and 50 kWh more generated energy is provided during the charging process. This amount of additional generated energy depends, among other things, on the duration of the charging process or the charging power with which an electric vehicle is charged.

Another embodiment example for the energy flow during the charging process between the components of the charging pole 1 is shown in FIG. 4. The primary energy source for the charging process is the fuel stored in the tank T (methanol/ethanol or a mixture of methanol and ethanol) with an assumed usable energy content of 6.28 kWh/I. The primary energy source for the charging process is the fuel (methanol/ethanol or a mixture of methanol and ethanol). The combustion engine M generates a nominal power of 180 kW, which is transmitted to the generator GE. The generator GE produces an electrical power of 180 kW. Of this 180 kW of electrical energy output, 30 kW is fed into battery B to charge it. A further 70 W of the energy output generated by the generator GE is used to supply power to the control unit S, the communication unit K and the HMI unit H. Therefore, 150 kW (minus 70 W for the operation of control unit S, communication unit K and HMI unit H) enters rectifier GR. The alternating current produced by the generator GE is converted into a direct current in the rectifier GR.

The direct current (around 150 kW) generated by the rectifier GE is fed into the charging cable located at the connection device A. The battery B with a capacity of 50 kWh supplies the control unit S, the communication unit K and the HMI unit H with a total of 70 W and the combustion engine M with 500 W in stand-by mode. In addition, in this embodiment example, the battery B feeds the rectifier GR with 50 kW of current power. This 50 kW of power is also fed as direct current to the energy storage unit of the electric vehicle to be charged and/or to a second electric vehicle to be charged, in addition to the approximately 150 kW of power generated by the generator GE. In particular, the rectifier GR functions as a power unit. Due to this advantageous configuration of the method according to the invention, the charging time is significantly reduced.

The ratio of the amount of electrical energy E_{K} generated during the charging process to the amount of electrical energy E_{A} delivered to the electric vehicle to be charged is advantageously greater than 1 (E_{K}/E_{A}>1). The more generated electrical energy output is 30 kW, according to the invention between 1 kWh and 50 kWh more generated energy is provided during the charging process. This amount of additional generated energy depends, among other things, on the duration of the charging process or the charging power with which an electric vehicle is charged.

The procedure for charging an electric vehicle begins with a registration of a first initial process. Up to this point, the charging pole 1 is in stand-by mode in which only the control unit S, the communication unit K and the HMI unit H are operational. The first initial process is registered by the connection of the charging cable to the electric vehicle to be charged, i.e. by means of a plug-in connection, charging pole 1 and electric vehicle are connected through the charging cable connected to connection device A. The first initial process puts the charging pole 1 into an operating state. For this purpose, the energy conversion process is started first. A starting device installed on the combustion engine M starts the combustion engine M, which is supplied with fuel from the tank T. The charging process is then started. Then the process of charging the electric vehicle by the electrical energy generated by the generator GE takes place. The electric vehicle is supplied with approximately 150 kW of electrical energy power by the charging pole 1 through the charging cable connected to the connection device A. Once the electric vehicle has been charged, the energy conversion process is terminated, the combustion engine M is stopped and the process of charging the electric vehicle is terminated. The charging pole 1 is returned into stand-by mode.

FIG. 5 shows a schematic view of the charging pole 1 according to the invention with representation of the connections by means of power lines between the components within the charging pole 1. In this embodiment example, the charging pole 1 also has an inverter WR. In the charging pole 1, the electrical energy for delivery to an electric vehicle is generated by the combustion engine M. The combustion engine M is a piston combustion engine with a shaft power of 180 kW, the combustion engine M is operated with methanol or ethanol or a mixture of methanol and ethanol. The fuel is stored in the charging pole 1 in the tank T.

The combustion engine M drives the generator GE by rotation. The kinetic energy generated by the combustion engine M is thus converted into electrical energy by the generator GE, into an alternating current. The generator GE produces an electrical power of 180 kW. The alternating current generated by the generator GE is converted into a direct current in the rectifier GR.

The HMI unit H has the display and operating terminal on which the data important for a user, such as charging current, charging duration and costs of the charging process, are retrieved and displayed. In addition, a user can initiate or end the charging process and pay.

The rechargeable battery B (battery) has a capacity of 50 kWh and is charged by the generator GE during the charging process. At the same time, the battery B supplies the control unit S, the communication unit K and the HMI unit H with electrical energy for operation and the combustion engine M with electrical energy for starting and operation.

The charging pole 1 also has the connection device A for one or more charging cables with which an electric vehicle to be charged is charged. The charging cable also has a data line that establishes a data connection between the control unit S and the electric vehicle. Communication with the battery of the electric vehicle to be charged is established via the data line and the required data such as state of charge, charging voltage and charging current are queried. The control unit S sets the parameters of the charging current on the basis of this data. The charging pole 1 is connected to the operator of the charging pole 1 and a plurality of charging poles via the communication unit K, which establishes an internet connection, e.g. with a cloud storage.

In this embodiment, the battery B is connected to the connection device A for the charging cable via an inverter WR. During the charging process, the inverter GW functions as a power unit that adjusts the charging state of the electric vehicle to be charged, the charging voltage and the charging current of the charging pole. In this example, a first electric vehicle to be charged is charged with approximately 150 kW direct current, and a second electric vehicle to be charged is charged with 50 kW alternating current by the battery B.

The procedure for charging an electric vehicle begins with a registration of a first initial process. Up to this point, the charging pole 1 is in a stand-by mode in which only the control unit S, the communication unit K and the HMI unit H are operational. These units H, K, S are supplied with energy by the battery B. The control unit S, the communication unit K and the HMI unit H require 70 W for stand-by operation. The first initial process is registered by the connection of the charging cable to the electric vehicle to be charged, i.e. by means of a plug-in connection, charging pole 1 and electric vehicle are connected through the charging cable connected to connection device A. The first initial process puts the charging pole 1 into an operating state. For this purpose, the energy conversion process is started first. A starting device installed on the combustion engine M starts the combustion engine M, which is supplied with fuel from the tank T. The combustion engine M is started by the starting device. For the start and operation of the combustion engine M, an electrical power of 500 W is required, which is provided by the battery B. The battery is then charged. Then the process of charging the electric vehicle is carried out by the electrical energy generated by the generator GE. Typically, a user gives a start command for charging via the HMI unit H. The electric vehicle is supplied with electrical energy by the charging pole 1 through the charging cable connected to the connection device A, in this example with a maximum of 150 kW. After the electric vehicle has been charged, the energy conversion process is terminated, the combustion engine M is stopped and the process of charging the electric vehicle is terminated. No more electrical energy flows from the charging pole 1 to the electric vehicle. The charging pole 1 is returned into stand-by mode.

The ratio of the amount of electrical energy E_{K} generated during the charging process to the amount of electrical energy E_{A} delivered to the electric vehicle to be charged is greater than 1 according to the invention, i.e. the charging pole 1 generates more electrical energy than is delivered to the electric vehicle. The more generated electrical energy output is 30 kW, according to the invention between 1 kWh and 50 kWh more generated energy is provided during the charging process. This amount of additional generated energy depends, among other things, on the duration of the charging process or the charging power with which an electric vehicle is charged.

Another embodiment example for the energy flow during the charging process between the components of the charging pole 1 is shown in FIG. 6. The primary energy source for the charging process is the fuel (methanol/ethanol or a mixture of methanol and ethanol) stored in the tank T with an assumed usable energy content of 6.28 kWh/I. The fuel is used for the charging process. The combustion engine M generates a nominal power of 180 kW, which is transmitted to the generator GE. The generator GE produces an electrical power of 180 kW. Of this 180 kW of electrical energy output, 30 kW is fed into battery B to charge it. A further 70 W of the energy output generated by the generator GE is used to supply power to the control unit S, the communication unit K and the HMI unit H. Therefore, 150 kW (minus 70 W for the operation of control unit S, communication unit K and HMI unit H) goes into rectifier GR. The alternating current generated by the GE generator is converted into a direct current in the GR rectifier. The direct current (approximately 150 kW) generated by the rectifier GE is fed into the charging cable located at connection device A. The battery B with a capacity of 50 kWh supplies the control unit S, the communication unit K and the HMI unit H with a total of 70 W and the combustion engine M with 500 W in stand-by mode.

In addition, in this embodiment example, the battery B feeds the rectifier with 50 kW of power. This 50 kW of power is also fed as direct current to the energy storage unit of the electric vehicle to be charged and/or to a second electric vehicle to be charged in addition to the approximately 150 kW of power generated by the generator GE. In particular, the rectifier GR functions as a power unit. Due to this advantageous configuration of the method according to the invention, the charging time is significantly reduced.

The ratio of the amount of electrical energy E_{K} generated during the charging process to the amount of electrical energy E_{A} delivered to the electric vehicle to be charged is advantageously greater than 1 (E_{K}/E_{A}>1).

Advantageously, the charging pole 1 according to the invention generates more electrical energy E_{K} during the charging process than the amount of energy E_{A} delivered to the electric vehicle to be charged. This more generated energy E_{K} not only compensates for the loss energy E_{V}, which is unavoidable for all technical systems (E_{K}/(E_{A}+E_{V})>1). In addition, the additional energy E_{K} is greater than the sum of the amount of electrical energy E_{A} delivered to the electric vehicle to be charged, the loss energy E_{V} and the amount of electrical energy E_{S} stored in the battery B (E_{K}/(E_{A}+E_{V}+E_{S})>1). In all the examples presented here, the additional energy generated during the charging process is 50 kWh.

The procedure for charging an electric vehicle begins with a registration of a first initial process. Up to this point, the charging pole 1 is in stand-by mode in which only the control unit S, the communication unit K and the HMI unit H are operational. The first initial process is registered by the connection of the charging cable to the electric vehicle to be charged, i.e. by means of a plug-in connection, charging pole 1 and electric vehicle are connected through the charging cable connected to connection device A. The first initial process puts the charging pole 1 into an operating state. For this purpose, the energy conversion process is started first. A starting device installed on the combustion engine M starts the combustion engine M, which is supplied with fuel from the tank T. The charging process is then started. Then the process of charging the electric vehicle by the electrical energy generated by the generator GE takes place. The electric vehicle is supplied with approximately 150 kW of electrical energy power by the charging pole 1 through the charging cable connected to the connection device A. Once the electric vehicle has been charged, the energy conversion process is terminated, the combustion engine M is stopped and the process of charging the electric vehicle is terminated. The charging pole 1 is returned into stand-by mode.

In this embodiment, the battery B is connected to the connection device A for the charging cable via an inverter WR. During the charging process, the inverter GW functions as a power unit that adjusts the charging state of the electric vehicle to be charged, the charging voltage and the charging current of the charging pole. In this example, a first electric vehicle to be charged is charged with approximately 150 kW direct current, and a second electric vehicle to be charged is charged with 50 kW alternating current by the battery B.

FIG. 7 shows a schematic view of the charging pole 1 according to the invention, showing the connections by means of power lines between the components within the charging pole 1. In this embodiment, the charging pole 1 has a direct current generator GGE and two inverters GW.

In the charging pole 1, the electrical energy for delivery to an electric vehicle is generated by the combustion engine M. The combustion engine M is a piston combustion engine with a shaft power of 180 kW, the combustion engine M is operated with methanol or ethanol or a mixture of methanol and ethanol. The fuel is stored in the charging pole 1 in the tank T.

The combustion engine M drives the generator GGE by rotation. The kinetic energy generated by the combustion engine M is converted into electrical energy by the generator GGE, into a direct current. The generator GGE generates an electrical power of 180 kW. The direct current generated by the generator GGE is converted into an alternating current in the inverter GW. An electric vehicle to be charged is thus charged with an alternating current in this embodiment example. This may be necessary in particular if the electric vehicle to be charged has a built-in rectifier.

The HMI unit H has the display and operating terminal on which the data important for a user, such as charging current, charging duration and costs of the charging process, are retrieved and displayed. In addition, a user can initiate or end the charging process and pay. The rechargeable battery B (battery) has a capacity of 50 kWh and is charged by the generator GGE via a second inverter GW during the charging process.

During the charging process, the inverter GW between the generator GGE and battery B acts as a power unit that regulates the current and voltage of the charging current of the battery B. Typically, this is 12 V or 24 V at less than 200 A, while the charging current for charging the electric vehicle is 400 V at a maximum of 500 A. At the same time, the battery B supplies the control unit S, the communication unit K and the HMI unit H with electrical energy for operation, as well as the combustion engine M with electrical energy for starting and operation.

The charging pole 1 also has the connection device A for one or more charging cables with which an electric vehicle to be charged is charged. The charging cable also has a data line that establishes a data connection between the control unit S and the electric vehicle. Communication with the battery of the electric vehicle to be charged is established via the data line and the required data such as state of charge, charging voltage and charging current are queried. The control unit S sets the parameters of the charging current based on this data. The charging pole 1 is connected to the operator of the charging pole 1 and a plurality of charging poles via the communication unit K, which establishes an internet connection, e.g. with a cloud storage.

In this embodiment, the battery B is connected to the connection device A for the charging cable via an inverter WR. During the charging process, the inverter GW functions as a power unit that adjusts the charging state of the electric vehicle to be charged, the charging voltage and the charging current of the charging pole. In this example, a first electric vehicle to be charged is charged with approximately 150 kW direct current, and a second electric vehicle to be charged is charged with 50 kW alternating current by the battery B.

The procedure for charging an electric vehicle begins with a registration of a first initial process. Up to this point, the charging pole 1 is in a stand-by mode in which only the control unit S, the communication unit K and the HMI unit H are operational. These units H, K, S are supplied with energy by the battery B. The control unit S, the communication unit K and the HMI unit H require 70 W for stand-by operation.

The first initial process is registered by the connection of the charging cable to the electric vehicle to be charged, i.e. by means of a plug-in connection, charging pole 1 and electric vehicle are connected by the charging cable connected to connection device A. The first initial process puts the charging pole 1 into an operating state. For this purpose, the energy conversion process is started first. A starting device installed on the combustion engine M starts the combustion engine M, which is supplied with fuel from the tank T. The combustion engine M is started by the starting device. For the start and operation of the combustion engine M, an electrical power of 500 W is required, which is provided by the battery B. The battery is then charged. Then the process of charging the electric vehicle is carried out by the electrical energy generated by the generator GE. Typically, a user gives a start command for charging via the HMI unit H. The electric vehicle is supplied with electrical energy by the charging pole 1 through the charging cable connected to the connection device A, in this embodiment example with a maximum of 150 kW. After the electric vehicle has been charged, the energy conversion process is terminated, the combustion engine M is stopped and the process of charging the electric vehicle is terminated. No more electrical energy flows from the charging pole 1 to the electric vehicle. The charging pole 1 is returned into stand-by mode.

The ratio of the amount of electrical energy E_{K} generated during the charging process to the amount of electrical energy E_{A} delivered to the electric vehicle to be charged is greater than 1 according to the invention, i.e. the charging pole 1 generates more electrical energy than is delivered to the electric vehicle. The more generated electrical energy output is 30 kW, according to the invention between 1 kWh and 50 kWh more generated energy is provided during the charging process. This amount of additional generated energy depends, among other things, on the duration of the charging process or the charging power with which an electric vehicle is charged.

### REFERENCE LIST

1 Charging pole
H HMI unit
GW DC converter
GE Generator
S Control unit
K Communication unit
B Battery/rechargeable battery/rechargeable electric energy storage unit
A Connection device for charging cable
T Tank unit
GR Rectifier
WR Inverter
GGE DC generator
G Housing
M Combustion engine

1. A process for generating and delivering charging current for an electric vehicle in a charging pole, having the following steps
registering a first initial process for charging an electric vehicle
starting an energy conversion process
starting an electric vehicle charging process
termination of the energy conversion process
ending the process of charging an electric vehicle
characterised in that
the ratio of the amount of electrical energy E_{K} generated during the charging process to the amount of electrical energy E_{A} delivered to the electric vehicle to be charged is
E_{K}/E_{A}>1.

2. The process for generating and delivering charging current for an electric vehicle in a charging pole according to claim 1
characterised in that
the ratio of the amount of electrical energy generated during the charging process E_{K} to the amount of electrical energy delivered to the electric vehicle to be charged E_{A} and the amount of electrical energy lost E_{V} is
E_{K}/(E_{A}+E_{V})>1.

3. The process for generating and delivering charging current for an electric vehicle in a charging pole according to claim 2
characterised in that
the ratio of the amount of electrical energy E_{K} generated during the charging process to the sum of the amount of electrical energy E_{A} delivered to the electric vehicle to be charged, the amount of electrical energy lost E_{V} and the amount of electrical energy E_{S} stored during the charging process is
E_{K}/(E_{A}+E_{V}+E_{S})>1.

4. The process for generating and delivering charging current for an electric vehicle in a charging pole according to claim 1,
characterised in that
the storage of the energy E_{S} takes place in an electrical energy storage device.

5. The process for generating and delivering charging current for an electric vehicle in a charging pole according to claim 1,
characterised in that
the additional electrical energy generated E_{M} is greater than or equal to 1 kWh.

6. The process for generating and delivering charging current for an electric vehicle in a charging pole according to claim 1,
characterised in that
the additional electrical energy generated E_{M} is less than or equal to 50 kWh.

7. The process for generating and delivering charging current for an electric vehicle in a charging pole according to claim 1,
characterised in that
the stored electrical energy E_{S} is greater than or equal to 5 kWh.

8. The process for generating and delivering charging current for an electric vehicle in a charging pole according to claim 1,
characterised in that
part of the additional electrical energy E_{M} generated is transferred to a second vehicle to be charged in parallel.

9. The process for generating and delivering charging current for an electric vehicle in a charging pole according to claim 1,
characterised in that
part of the additional electrical energy generated E_{M} is used to operate the charging pole.

10. The process for generating and delivering charging current for an electric vehicle in a charging pole according to claim 1,
characterised in that
the energy conversion comprises the conversion of a liquid and/or gaseous energy carrier into electrical energy.

11. The process for generating and delivering charging current for an electric vehicle in a charging pole according to claim 10
characterised in that
the liquid energy carrier from a tank is used in the charging pole.

12. A charging pole suitable and intended for charging electric vehicles, comprising
an energy conversion device
a generator unit connected to the energy conversion device
a rectifier connected to the generator unit,
wherein the rectifier is connected via a power line to a connection for a charging cable
characterised in that
a consumer and/or an energy storage device is connected to the generator unit via a power line,
wherein the power line is suitable and intended for transmitting electrical energy for the operation of the consumer or for the storage of the electrical energy.

13. The charging pole suitable and intended for charging electric vehicles according to claim 12
characterised in that
the consumer comprises an HMI and/or power unit.

14. The charging pole suitable and intended for charging electric vehicles according to claim 12
characterised in that
the HMI unit comprises a screen, a control device, a sensor unit, communication unit and/or a controller.

15. The charging pole suitable for charging electric vehicles and intended therefor, according to claim 12
characterised in that
the battery (the power storage device, see claim 12) is connected to the energy conversion device via a power line,
the power line being suitable and intended for transmitting electrical energy for starting and/or operating the energy conversion device.

16. The charging pole suitable for charging electric vehicles and intended therefor, according to claim 12
characterised in that
the battery is connected to the HMI/power unit via a power line,
wherein the power line is suitable and intended for transmitting electrical energy for start, stand-by and/or operation of the HMI/power unit.

17. The charging pole suitable for charging electric vehicles and intended therefor, according to claim 12
characterised in that
the battery is connected to the charging cable via a power line,
wherein the power line is suitable and intended for transmitting electrical energy to the charging cable for charging the electric vehicle.

18. The charging pole suitable for charging electric vehicles and intended therefor, according to claim 12
characterised in that
the battery is connected to the rectifier via a power line,
the power line being suitable and intended for transmitting electrical energy to the rectifier for conversion of the current.

19. The charging pole suitable and intended for charging electric vehicles according to claim 18
characterised in that
the battery is connected to the rectifier via inverter.

20. The charging pole suitable for charging electric vehicles and intended therefor, according to claim 12
characterised in that
the battery is connected to the generator unit via a power line,
wherein the power line is suitable and intended for storing the electrical energy transmitted by the generator unit in the battery.
